(19) United States
(12) Patent Application Publication
(10) Pub. No.: US 2019/0012677 A1
(43) Pub. Date: Jan. 10, 2019

(54) SERVICE CONTRACT RENEWAL LEARNING SYSTEM

(71) Applicant: General Electric Company, Schenectady, NY (US)

(72) Inventors: Jojo John MOOLAYIL, Bangalore (IN); Vikrant DAMLE, Bangalore (IN); Soujanya ALURI, Bangalore (IN); Manohar SWAMYNATHAN, Bangalore (IN)

(21) Appl. No.: 15/642,853

(22) Filed: Jul. 6, 2017

(51) Int. Cl. G06Q 30/00; G06Q 30/02

(52) U.S. Cl. CPC G06Q 30/012; G06Q 30/0255; G06Q 30/0254

(57) ABSTRACT

The example embodiments are directed to a system and method for generating a service contract renewal propensity, and taking action based on the determined propensity. In one example, the method includes generating a service contract renewal propensity model for an asset based on historical service contract information associated with the asset, determining a propensity of a consumer of the asset to renew a service contract between the consumer and a service provider, wherein the determining includes processing the service contract renewal propensity model based on input asset information and input consumer information associated with the service contract, determining at least one reminder operation to be performed, from among a plurality of reminder operations, based on the determined propensity of the consumer to renew the service contract, and outputting information about the determined at least one reminder operation to be performed for display on a display device.

### BACKGROUND

Machine and equipment assets, generally, are engineered to perform particular tasks as part of a business process. For example, assets can include, among other things and without limitation, industrial manufacturing equipment on a production line, drilling equipment for use in mining operations, wind turbines, solar panels, etc., which generate electricity, transportation vehicles such as trains, automobiles, aircraft, and the like. As another example, assets may include healthcare machines and devices that aid in diagnosing patients such as imaging systems (e.g., X-ray or MM systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies have created opportunities for creating novel industrial and healthcare based assets which are capable of transmitting data that can then be distributed throughout a network. As a consequence, there are new opportunities to enhance the business value of some assets, data associated with the assets, and asset manufacturers through the use of novel industrial-focused hardware and software.

A service contract (e.g., also referred to as an extended warranty, service agreement, maintenance agreement, etc.) is a business agreement offered to consumers in addition to a standard warranty provided on newly manufactured assets. A service contract is often an agreement between the provider of the contract and the consumer covering maintenance and servicing of the machine or equipment over a specified period of time. In some cases, the service contract may be provided by a third party service provider, a retailer of the asset, a manufacturer of the asset, and the like. A service contract typically costs the consumer a percentage of the asset's purchase price and covers most maintenance and servicing that can occur with respect to the asset and its parts.

For manufacturers and machinery industries, service contracts contribute to a significant portion of the annual revenue. For example, service contracts can account for 25% to 50% of a business's revenue. Ineffective control and management of supplier contracts costs businesses in the United States alone, approximately $150 billion per year in missed savings opportunities. For example, even a minor delay (e.g., 2-3 weeks) in contract renewals may result in a significant loss of revenue. Accordingly, what is needed is an improved tool for identifying service contract renewal opportunities and facilitating renewal of the service contract in instances where there is a possibility of improvement.

### SUMMARY

Embodiments described herein improve upon the prior art by providing systems and methods which can analyze service contract data, consumer data, and other attributes associated with the service contract or the asset under the service contract, and determine actions to take in order to facilitate renewal of the service contract. The systems and methods can reduce losses that occur from delayed or defaulting service contracts and leverage visibility into the future by determining likely candidates to default, and possible actions to take to prevent the default. Also, the system and method can optimize efforts in targeting consumers that are likely to renew their service contract but who may be a candidate for a delay in renewing the service contact. In some examples, the embodiments herein may be incorporated within software that is deployed on a cloud platform for use with an Internet of Things (IoT) system.

In an aspect of an example embodiment, a computer-implemented method includes generating a service contract renewal propensity model for an asset based on historical service contract information associated with the asset, determining a propensity of a consumer of the asset to renew a service contract between the consumer and a service provider, wherein the determining includes processing the service contract renewal propensity model to input asset information and input consumer information associated with the service contract, determining at least one reminder operation to be performed, from among a plurality of reminder operations, based on the determined propensity of the consumer to renew the service contract, and outputting information about the determined at least one reminder operation to be performed for display on a display device.

In an aspect of another example embodiment, a computing system includes a processor configured to generate a service contract renewal propensity model for an asset based on historical service contract information associated with the asset, determine a propensity of a consumer of the asset to renew a service contract between the consumer and a service provider, wherein the determining comprises processing the service contract renewal propensity model based on input asset information and input consumer information associated with the service contract, and determine at least one reminder operation to be performed, from among a plurality of reminder operations, based on the determined propensity of the consumer to renew the service contract. The computing system may also include an output configured to output information about the determined at least one reminder operation to be performed for display on a display device.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing environment for determining a service contract renewal propensity in accordance with an example embodiment.

FIG. 2 is a diagram illustrating a system for generating a service contract renewal propensity model in accordance with an example embodiment.

FIG. 3 is a diagram illustrating a user interface outputting information based on service contract renewal propensity in accordance with an example embodiment.

FIG. 4 is a diagram illustrating a method for determining a service contract renewal propensity in accordance with an example embodiment.

FIG. 5 is a diagram illustrating a computing system for determining a service contract renewal propensity in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a service agreement renewal analytic software which can be used by manufacturers, service contract providers, sales representatives, and the like, to increase renewals of service contracts by exposing a high degree of visibility in the service contract renewal process. For example, the analytic can predict the probability (i.e., propensity) that a customer will renew a service agreement for a particular asset based on various data such as customer information, asset information, and contract information. The analytic may consider a customer's financial information, renewal history with other service contracts, geographic location of the asset, type of asset (modality), terms of the service agreement, previous service requests made by customer, etc. The analytic can also provide a listing of other assets of the customer along with when respective service agreements of those other assets will be in default. In addition, the analytic may also provide visibility into historic renewal rates and renewal gaps for assets across various dimensions. The analytic can also provide suggested actions that can be taken by a user to increase the likelihood of the service contract being renewed.

For industries such as transportation, healthcare, energy, and manufacturing, there is a significant percentage of company revenue that is generated from service agreements. A typical service agreement obligates the service provider to perform maintenance and other repairs on a given asset for a predetermined period of time. Service agreements often have a yearly term or multi-year term. When a service agreement ends, the customer is faced with a decision of whether to renew a service agreement or let it lapse and go without. In some cases, there is often a period of time between when an existing service agreement expires and the customer renews the service agreement (e.g., 2-4 months). The example embodiments provide a service agreement analytical software that can identify service agreements that are set to expire, the likelihood of the customer renewing the service agreement, and the likelihood of the customer being late to renew the service agreement. Furthermore, the software can provide actions to a user, such as a sales representative, to best inform the customer of the pending expiration of the agreement was well as timely reminders and offers to entice the customer to renew the agreement.

Service agreements may be for assets included in industrial and/or manufacturing based equipment, machines, devices, etc., and may include healthcare machines, industrial machines, manufacturing machines, chemical processing machines, textile machines, locomotives, aircraft, energy-based machines, oil rigs, and the like. The service agreement analytical software may analyze historical service agreements generated in association with an asset, and generate a predictive model that can determine the propensity of a customer to renew a service agreement.

The service agreement analytical software may be deployed on a cloud platform computing environment, for example, an Internet of Things (IoT) or an Industrial Internet of Things (IIoT) based platform. While progress with machine and equipment automation has been made over the last several decades, and assets have become ‘smarter,’ the intelligence of any individual asset pales in comparison to intelligence that can be gained when multiple smart devices are connected together, for example, in the cloud. Assets, as described herein, may refer to equipment and machines used in fields such as energy, healthcare, transportation, heavy manufacturing, chemical production, printing and publishing, electronics, textiles, and the like. Aggregating data collected from or about multiple assets can enable users to improve business processes, for example by improving effectiveness of asset maintenance or improving operational performance if appropriate industrial-specific data collection and modeling technology is developed and applied.

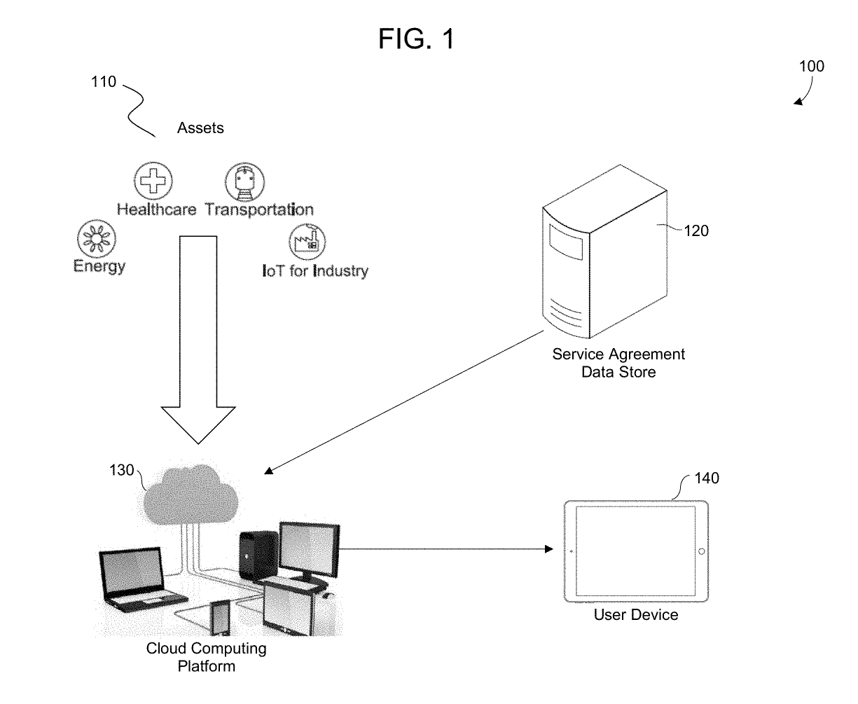

FIG. 1 illustrates a cloud-based system 100 for generating and applying service agreement analytics in accordance with an example embodiment. In this example, service agreements are associated with one or more types of assets. As an example, the service agreement may be a service contract between a customer or an owner of an asset, and a manufacturer or a retailer of the asset. Referring to FIG. 1, the system 100 includes a group of assets 110, service agreement data store 120, a cloud computing platform 130 that represents a cloud-based environment according to various embodiments, and a user device 140. It should be appreciated that the system 100 is merely an example and may include additional devices and/or one of the devices shown may be omitted. As another example, the software described herein may be included on a single device without the interaction of a system. The cloud computing platform 130 may be one or more of a server, a computer, a database, and the like, included in a cloud-based platform. The user device 140 may include a computer, a laptop, a tablet, a mobile device, a television, an appliance, a kiosk, and the like. In the example of FIG. 1, the assets 110, the SME data store 120, and/or the user device 140 may be connected to the cloud platform 130 via a network such as the Internet.

An asset 110 may be outfitted with one or more sensors configured to monitor respective operations or conditions. Data from the sensors can be recorded or transmitted to the cloud-based or other remote computing environment described herein. By bringing such data into a cloud-based computing environment 100, the data may be analyzed and issues such as machine or equipment failure may be identified based on a totality of evidence (e.g., textual data, sensor data, etc.) from multiple and different sources. Service contracts associated with the assets 110 may be stored in the service agreement data store 120. Insights gained through analysis of such data can lead to an enhanced analytic that is capable of determining the propensity of any given customer to renew a service contract for an asset 110. In addition, other analytics may be used to analyze asset data, evaluate, and further understand issues related to operation of the asset within manufacturing and/or industry.

According to various embodiments, the service contract analytic software learns from historical service contracts of an asset and of various customers, generates a service contract renewal propensity model based on data from the historical service contracts, and applies the service contract renewal propensity model to service contracts set to expire to determine the likelihood of the customer to renew the service contract, and also the propensity of the customer to be late in renewing the service agreement. The service agreement analytic software may be deployed on the cloud computing platform 130. The software may receive new service agreement data associated with an asset and a customer and determine the propensity of the service agreement to be renewed. The analytic may also identify gaps or areas of reminders/incentives that can be offered to a customer to improve the propensity of renewal as well as improve the timeliness of the renewal.

Service contract data for a plurality of service contracts associated with an asset may be stored in the service agreement data store 120. For example, for each service contract, one or more of an asset type, a geographic location of the asset, customer financial information, customer previous renewal history, customer service requests, and the like, can be stored in the service agreement data store 120. This data can be analyzed and machine learning algorithms may be applied to the data to generate a service agreement renewal propensity model based on various factors about the asset and about the customers. The model can be used to predict whether a pending service agreement will be renewed by inputting various customer information and/or asset information into the model.

The software application described herein and deployed on the cloud platform 130 in FIG. 1 may learn from the historical service agreement data stored in the SME data store 120, and generate the service agreement renewal propensity model based thereon. For example, the historical information provided in connection with an asset may be analyzed and clustered or modeled into different propensity groups having different qualities and other attributes. As will be appreciated, different attributes of the asset as well as different attributes of the customer can affect whether the customer will renew a service contract. For example, a healthcare machine or a manufacturing machine may have hundreds of parts and/or software that need repair or replacement. In this case, it might be worth the expense of the customer to renew the service agreement for as long as possible. As another example, an asset may have a geographical location that makes the asset more likely to break down such as extreme heat or extreme cold environments. This may cause the customer to be more likely to renew the service agreement. As will be appreciated, there are dozens of factors that can affect the propensity of a service agreement renewal. Here, the service agreement renewal propensity model can take into account these different factors and provide a yes or no answer as to whether a customer will renew their service contract. As another example, the model can provide a likelihood percentage (e.g., between 0% and 100%) of whether the customer will renew their service contract.

When data from a service contract to be analyzed is received, for example, from an asset 110 or a system associated with the asset 110, the service contract data may processed by the service agreement analytical software deployed on the cloud platform 130 to automatically determine a propensity of the service contract to be renewed. Furthermore, additional information such as propensity of the service contract to be renewed late, as well as information about the customer and other related service contracts may be identified. The service contract determination and other data may be output to a display screen of the user device 140, or another device. For example, the user device 140 (e.g., computer, mobile device, workstation, tablet, laptop, appliance, kiosk, and the like) may be configured for data communication with the cloud computing platform 130. The user device 140 can be used to manage reminders, incentives, and the like, for service agreements associated with the assets 110. The user device 140 can include options and hardware for scheduling service and/or parts for the asset 110.

The service contract analytical software described according to various embodiments is a tool that can be used by a sales team or other user responsible for timely renewing service contracts with customers. The tool predicts a customer's contract renewal propensity, in advance, and aids the sales representative team to take corrective steps in targeting a renewal defaulting customer thereby boosting sales. The tool leverages a variety of data sources to build a robust predictive model using cutting edge machine learning techniques and advanced feature engineering.

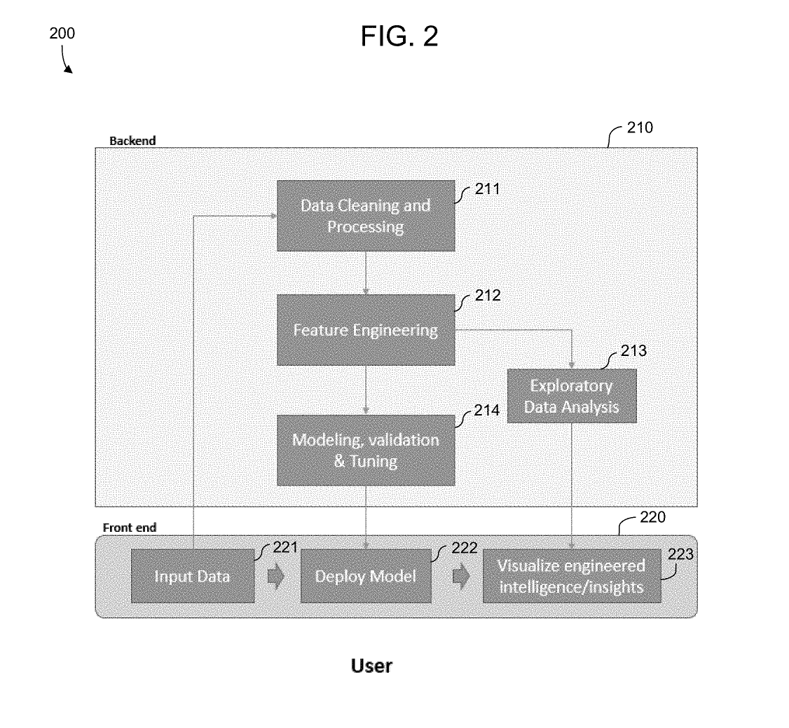

FIG. 2 illustrates a system 200 for generating a service contract renewal propensity model in accordance with an example embodiment. In this example, the system 200 includes a back-end 210 and a front-end 220. As a non-limiting example, the back-end 210 may be a cloud platform, a server, a computer, and/or the like. Meanwhile, the front-end 220 may connect to the back-end 210 via a network such as the Internet, a private network, and/or the like. The front-end 220 may include a user device such as a desktop computer, a laptop, a tablet, a mobile phone, and the like. The back-end 210 may include a processor and a storage. The processor may execute the service contract analytical software described herein to build a predictive service contract renewal model by intelligently extracting domain rich and relevant intelligence from various data sources such as contract data, transactional data, customer demographics and asset details. These intelligent data signals may be pooled together as input for cutting edge machine learning algorithms to learn/train and build a model to achieve high accuracy.

The overall process can be broken down into multiple steps including data processing/cleaning, domain specific feature engineering, and modeling, evaluation and tuning. Referring to FIG. 2, in data processing 211, flat files of data may be uploaded and stored and may be tailored to coherently fit the modelling process. For example, the data processing step may include cleaning the data and preparing the data into a format which would ease the further steps. Cleaning the data may include checking for data consistency, removing outliers, treating categorical and date-time variables, treating missing values, reducing noise in the data, and the like.

Post data cleaning, in 212, feature engineering techniques can be used to develop intelligence and domain specific features from the available data. Many features intrinsic to service contract renewals may be created during this step. The featuring engineering process builds intelligence for the tool to deliver actionable outcomes. For example, the feature engineering process 212 may build intelligence around customer related signals, asset related signals, historic renewal patterns, contract related patterns and many others. Furthermore, the feature engineering may analyze training data or even real data, in 213.

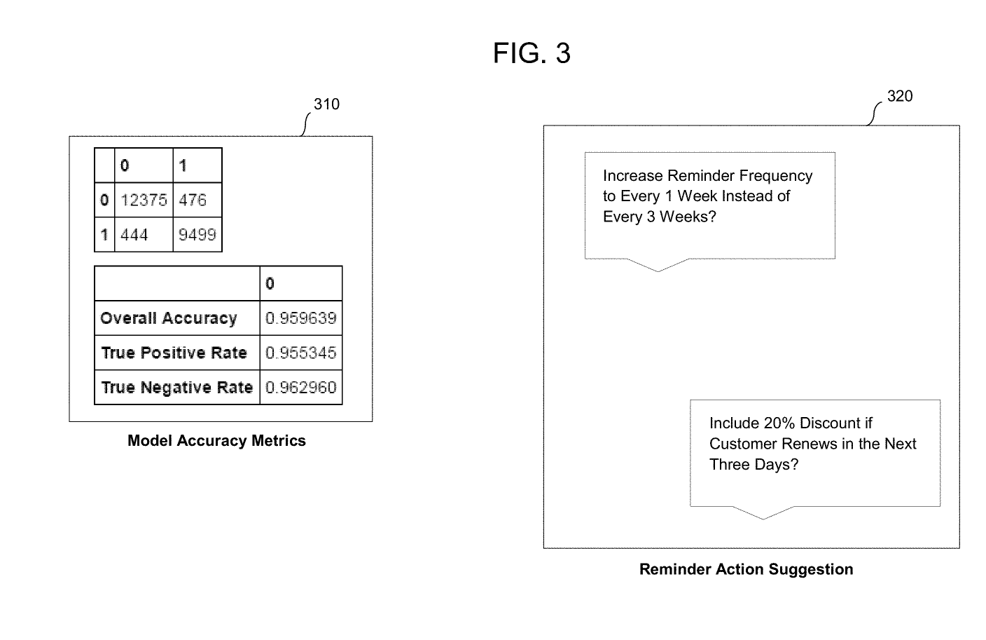

Once the exhaustive list of domain intrinsic features/intelligence are engineered from the data during the feature engineering step, in 214 the new data is ready to be modeled. For example, the modeling may include building predictive machine learning models that can determine the propensity of a service contract to be renewed. An ensemble of cutting edge machine learning techniques may be used to deploy a robust and generalized model that can be leveraged for any industry/use-case. The model may be further tested with unseen validation datasets to improve accuracy and generalizing capabilities. An example of a model being tested in shown in 310 of FIG. 3 where an accuracy of a propensity model is shown based on training data. Numerous iterations of the model building activity may be executed to refine the machine learning models and deliver state of the art predictive results.

When the model has been built, the user 220 such as a sales representative may execute the service contract analytical software to determine a likelihood of a customer renewing a service contract. For example, in 221 the user may enter data from or about an existing service contract, information about the customer, information about the asset, and the like. In 222, the model built in 214 may be deployed based on the input data in 221, and a prediction of the propensity of the customer to renew the service contract can be generated and displayed in 223. The deployed model in 222 may be used to analyze the service contract data and other data of the customer and/or the asset, to make a prediction about whether the customer will renew the service agreement. Based on the prediction, additional actions may be determined by the system such as reminder options 320 shown in FIG. 3. The reminder options 320 may include sending periodic reminders, modifying an interval of time between periodic reminders, determining a point in time at which to begin sending reminders prior to the termination of the service contract, incentivizing the customer with offers or other benefits, and the like. In some embodiments, rather than output these potential actions to a screen, the system may automatically perform the action.

Service contract analytics may aid a sales team or any other responsible team to ensure on-time contract renewal and thereby boost revenue. The analytic may delve into a vast data pool and calibrate intelligence to deliver a tool with predictive capability on service contract renewals. The analytic may also provide visibility into the future by calculating the chances of a customer's propensity to renew the contract. These results can be leveraged weeks or even months in advance giving the team enough room to target the customers with appropriate campaigns/personalized messages or offers and reminders. It also provides a rich and insightful view into the historic patterns of contract renewals. These insights can be leveraged to optimize the limited bandwidth of the sales team to channelize the right set of customers for contract renewals.

Some advantages of the tool is the ability to deliver an end-to-end automated predictive solution that can be leveraged by any non-technical team to farm the existing set of customers for increasing the revenue from service contract renewals. This tool can be the most compelling differentiator for a sales team in prioritizing and optimizing the limited time bandwidth to target the right set of customers for timely contract renewals. The tool combines the right mix of hindsight and foresight to deliver actionable outcomes for sales representatives and other stake holders responsible for farming the existing customer base for maximizing revenue. Moreover, the tool brings in the state of art industry/domain neutral advantage. The tool can be applied to deliver outcomes in any industry vertical such as manufacturing, automobile, oil and gas, etc. The tool marinates the algorithm with indigenous learnings assimilated from decades of industrial presence.

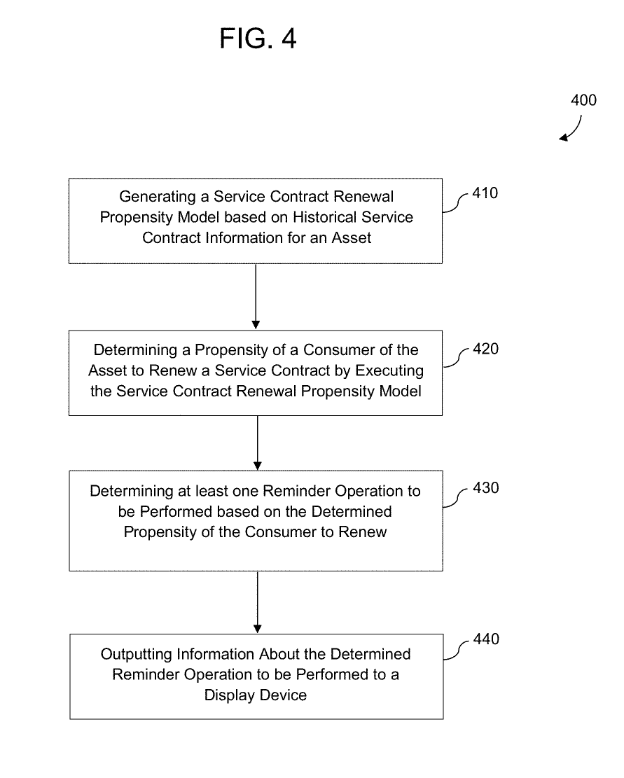

FIG. 4 illustrates a method for determining a service contract renewal propensity in accordance with an example embodiment. For example, the method may be performed by the service contract renewal propensity modeling software described herein and executed within a computing environment such as a clout platform, a user device, a server, and the like. Referring to FIG. 4, in 410, the method includes generating a service contract renewal propensity model for an asset based on historical service contract information associated with the asset. For example, the service contract renewal propensity model may be a matrix or model capable of predicting the propensity of a consumer for renewing a service contract associated with an asset of the consumer. Here, the service contract may be an agreement between the customer and a manufacturer, third party service provider, retailer, or the like. The model may be developed based on historical service agreements, previous history of the customer, a location of the asset, terms of the service agreement, financial information of customers, and the like.

In 420, the method includes determining a propensity of the consumer of the asset to renew a service contract between the consumer and a service provider of the service agreement. Here, the determining in 420 may include processing the service contract renewal propensity model software using asset information and consumer information associated with the service contract, as inputs. For example, the input asset information used by the service contract renewal propensity model may include one or more of a geographic location of the asset and features intrinsic to a type of the asset. The geographical location may include weather-related information, temperature, changes in environment, and the like. The features may include components, parts, materials used to construct the asset, and the like. Meanwhile, the input consumer information used by the service contract renewal propensity model may include at least one of a financial status of the consumer, previous renewal history of the consumer, and a number of historical service requests made by the consumer within a predetermined period of time, a number of other service contracts owned by the consumer, and the like. In some embodiments, the determining in 420 may further include determining the propensity of the consumer to be late in renewing the service contract and estimate how late the customer will be, based on the executed service contract renewal propensity model.

In 430, the method further includes determining at least one reminder operation to be performed, from among a plurality of possible reminder operations, based on the determined propensity of the consumer to renew the service contract. The reminder operation can be used to improve the chances that a consumer will renew a service agreement and go beyond a mere reminder email or message. For example, the reminder operation determined to be performed may include one or more of dynamically adjusting a period of time between sending reminders for renewing the service contract to the consumer, generating one or more offers in association with the service contract renewal, and transmitting the one or more offers to the consumer, determining a period of time prior before the end of the service contract at which to begin sending reminders to the consumer for renewing the service contract, and the like. Different reminder options may be better suited for certain customers based on consumer information and/or asset information associated with the service agreement. Accordingly, based on this information, the service contract renewal propensity model may base a recommended reminder action or actions based on the information.

In 440, the method further includes outputting information about the determined at least one reminder operation to be performed for display on a display device. For example, the reminder operation may be output to a user interface of a sales representative or manufacturer as a suggested action to take by the user. In addition, a listing of assets associated with the consumer and a point in time at which respective service agreements associated with the assets will be in default, may be output for display on the display device. For example, the information that is output may include suggest actions to be taken, service renewal data associated with a particular customer, service renewal data associated with a particular type of asset, and the like.

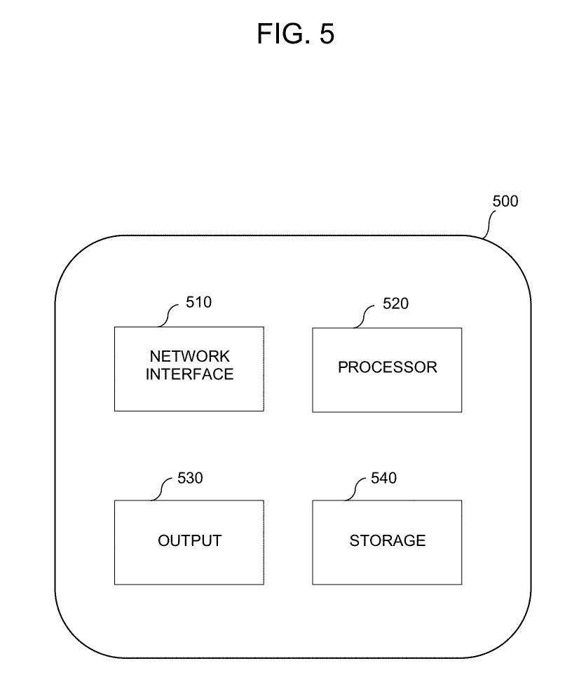

FIG. 5 illustrates a computing system 500 for determining a service contract renewal propensity in accordance with an example embodiment. For example, the computing system 500 may be a cloud platform, a server, a user device, or some other computing device with a processor. Also, the computing system 500 may perform the method of FIG. 4. Referring to FIG. 5, the computing system 500 includes a network interface 510, a processor 520, an output 530, and a storage device 540. Although not shown in FIG. 5, the computing system 500 may include other components such as a display, an input unit, a receiver/transmitter, and the like. The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. The output 530 may output data to an embedded display of the device 500, an externally connected display, a cloud, another device, and the like. The storage device 540 is not limited to any particular storage device and may include any known memory device such as RAM, ROM, hard disk, and the like.

The network interface 510 may receive and the storage device 540 may store historical service agreement information associated with a type of asset such as a machine or equipment. According to various embodiments, the processor 520 may generate a service contract renewal propensity model for an asset based on historical service contract information associated with the asset. The service contract renewal propensity model may map identify users more likely or less likely to renew and service contract agreements that are more likely or less likely to be renewed. The service contract renewal propensity model may be based on customer renewal history, customer financial information, customer service requests, and the like. As another example, the service contract renewal propensity model may be generated by the processor 520 based on the asset itself, such as a geographic location of the asset, a type of the asset, a condition of the asset, and the like.

The processor 520 may determine a propensity of a consumer of the asset to renew a service contract between the consumer and a service provider. For example, the processor 520 may apply the service contract renewal propensity model to input asset information and input consumer information associated with the service contract, and map the asset information and consumer information to an expected propensity of the customer to renew the service agreement. The processor 520 may also determine at least one reminder operation to be performed, from among a plurality of reminder operations, based on the determined propensity of the consumer to renew the service contract. In some embodiments, the processor 520 may also determine a propensity of the consumer to be late in renewing the service contract and how late the consumer will be, based on the executed service contract renewal propensity model.

The output 530 may output information identifying the determined at least one reminder operation to be performed to a display device of the computing system 500 or a display device of another user connected to the computing system 500 via a network, wire, or the like. As another example, rather than output the determined reminder operation to be performed, the processor 520 may automatically execute the reminder operation. The reminder operation to be performed may include one or more of dynamically adjusting (i.e., decreasing or increasing) an interval of time between sending reminders for renewing the service contract to the consumer, adding an offer in association with the service contract renewal, determining a period of time before the end of the service contract at which to begin sending reminders to the consumer for renewing the service contract, and the like. In some embodiments, the output 530 may output a listing of assets associated with the consumer and a point in time at which respective service agreements associated with the assets will be in default, for display on the display device.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computer-implemented method comprising:
generating a service contract renewal propensity model for an asset based on historical service contract information associated with the asset;
determining a propensity of a consumer of the asset to renew a service contract between the consumer and a service provider, wherein the determining comprises processing the service contract renewal propensity model based on input asset information and input consumer information associated with the service contract;
determining at least one reminder operation to be performed, from among a plurality of reminder operations, based on the determined propensity of the consumer to renew the service contract; and
outputting information about the determined at least one reminder operation to be performed for display on a display device.

2. The method of claim 1, wherein the input asset information used by the service contract renewal propensity model comprises a geographic location of the asset and features intrinsic to a type of the asset.

3. The method of claim 1, wherein the input consumer information used by the service contract renewal propensity model comprises at least one of a financial status of the consumer, previous renewal history of the consumer, and a number of historical service requests made by the consumer within a predetermined period of time.

4. The method of claim 1, wherein the determined at least one reminder operation to be performed includes dynamically adjusting a period of time between sending reminders for renewing the service contract to the consumer.

5. The method of claim 1, wherein the determined at least one reminder operation to be performed includes generating one or more offers in association with the service contract renewal, and transmitting the one or more offers to the consumer.

6. The method of claim 1, wherein the determined at least one reminder operation to be performed includes determining a period of time before an end of the service contract at which to begin sending reminders to the consumer for renewing the service contract.

7. The method of claim 1, wherein the outputting further comprises outputting a listing of assets associated with the consumer and a point in time at which respective service agreements associated with the assets will be in default, for display on the display device.

8. The method of claim 1, wherein the determining the propensity of the consumer to renew the service contract further comprises determining a propensity of the consumer to be late in renewing the service contract based on the executed service contract renewal propensity model.

9. A computing system comprising:
a processor configured to
generate a service contract renewal propensity model for an asset based on historical service contract information associated with the asset,
determine a propensity of a consumer of the asset to renew a service contract between the consumer and a service provider, wherein the determining comprises processing the service contract renewal propensity model based on input asset information and input consumer information associated with the service contract, and
determine at least one reminder operation to be performed, from among a plurality of reminder operations, based on the determined propensity of the consumer to renew the service contract; and
an output configured to output information about the determined at least one reminder operation to be performed for display on a display device.

10. The computing system of claim 9, wherein the input asset information used by the service contract renewal propensity model comprises a geographic location of the asset and features intrinsic to a type of the asset.

11. The computing system of claim 9, wherein the input consumer information used by the service contract renewal propensity model comprises at least one of a financial status of the consumer, previous renewal history of the consumer, and a number of historical service requests made by the consumer within a predetermined period of time.

12. The computing system of claim 9, wherein the determined at least one reminder operation to be performed by the processor includes dynamically adjusting a period of time between sending reminders for renewing the service contract to the consumer.

13. The computing system of claim 9, wherein the determined at least one reminder operation to be performed by the processor includes generating one or more offers in association with the service contract renewal, and transmitting the one or more offers to the consumer.

14. The computing system of claim 9, wherein the determined at least one reminder operation to be performed by the processor includes determining a period of time before an end of the service contract at which to begin sending reminders to the consumer for renewing the service contract.

15. The computing system of claim 9, wherein the output is further configured to output a listing of assets associated with the consumer and a point in time at which respective service agreements associated with the assets will be in default, for display on the display device.

16. The computing system of claim 9, wherein the processor is further configured to determine a propensity of the consumer to be late in renewing the service contract based on the executed service contract renewal propensity model.

17. A non-transitory computer readable medium having stored therein instructions that when executed cause a computer to perform a method comprising:
generating a service contract renewal propensity model for an asset based on historical service contract information associated with the asset;
determining a propensity of a consumer of the asset to renew a service contract between the consumer and a service provider, wherein the determining comprises processing the service contract renewal propensity model based on input asset information and input consumer information associated with the service contract;
determining at least one reminder operation to be performed, from among a plurality of reminder operations, based on the determined propensity of the consumer to renew the service contract; and
outputting information about the determined at least one reminder operation to be performed for display on a display device.

18. The non-transitory computer readable medium of claim 17, wherein the input asset information used by the service contract renewal propensity model comprises a geographic location of the asset and features intrinsic to a type of the asset.

19. The non-transitory computer readable medium of claim 17, wherein the input consumer information used by the service contract renewal propensity model comprises at least one of a financial status of the consumer, previous renewal history of the consumer, and a number of historical service requests made by the consumer within a predetermined period of time.

20. The non-transitory computer readable medium of claim 17, wherein the determining the propensity of the consumer to renew the service contract further comprises determining a propensity of the consumer to be late in renewing the service contract based on the executed service contract renewal propensity model.
